(19) United States
(12) Patent Application Publication
(10) Pub. No.: US 2016/0149192 A1
(43) Pub. Date: May 26, 2016

(54) BATTERY UNIT

(71) Applicant: PANASONIC INTELLECTUAL PROPERTY MANAGEMENT CO., LTD., Osaka-shi, Osaka (JP)

(72) Inventor: Shinya MOTOKAWA, Osaka (JP)

(21) Appl. No.: 14/896,134

(22) PCT Filed: Jul. 25, 2014
(86) PCT No.: PCT/JP2014/003928

§ 371 Date: Dec. 4, 2015

(30) Foreign Application Priority Data
Aug. 8, 2013 (JP) 2013-165445

(51) Int. Cl. H01M 2/20; H01M 2/12; H01M 2/34; H01M 2/10

(52) U.S. Cl. CPC H01M 2/206; H01M 2/1077; H01M 2/1252; H01M 2/348; H01M 2200/103

(57) ABSTRACT

A battery unit is equipped with: a plurality of battery stacks which each contain a plurality of battery cells and have a terminal unit electrically connected to the electrode of a battery cell and an exhaust port for discharging gas emitted from the battery cells; and a bus bar unit for supporting a bus bar member which electrically connects the terminal units of each battery stack. The bus bar unit is integrally provided with an exhaust duct for discharging the gas emitted from the battery cells to the exterior of the module, and connected to the exhaust ports of the battery stacks.

### CROSS REFERENCE TO RELATED APPLICATIONS

This is the U.S. national stage of application No. PCT/JP2014/003928, filed on Jul. 25, 2014. Priority under 35 U.S.C. §119(a) and 35 U.S.C. §365(b) is claimed from Japanese Application No. 2013-165445, filed Aug. 8, 2013, the disclosure of which is also incorporated herein by reference.

### TECHNICAL FIELD

The present invention relates to a battery unit configured by electrically connecting battery stacks, each of which includes a plurality of battery cells.

### BACKGROUND ART

Conventionally, for example, as described in Patent Literature 1, an assembled battery includes a plurality of battery units that include output terminals, connection means for electrically connecting the output terminals of different battery units with each other, and a fixation part that is attached to the output terminal so as to be insulated from the output terminal and that couples the connection means and the output terminal. It is described that the assembled battery makes it possible to perform easily and safely the electric connection between the battery units in the exterior of the battery units.

### CITATION LIST

### Patent Literature

Patent Literature 1: Japanese Patent Laid-Open Publication No. 2008-71638

### SUMMARY OF INVENTION

### Technical Problem

The connection means in the above Patent Literature 1 are shown as plate-shaped members including a plurality of bus bars that electrically connect the output terminals of the battery units with each other, but a configuration for exhausting the gas emitted from an electric cell (or battery cell) included in each battery unit is not considered.

### Solution to Problem

A battery unit according to the present invention is a battery unit including: a plurality of battery stacks, each of which includes a plurality of battery cells and has a terminal and an exhaust port, the terminal being electrically connected with electrodes of the battery cells, the exhaust port exhausting gas emitted from the buttery cells; and a bus bar unit that supports a bus bar member electrically connecting terminal parts of the battery stacks with each other, in which an exhaust duct is integrally provided on the bus bar unit, the exhaust duct being an exhaust duct for ejecting the gas emitted from the battery cells to an exterior of a module and being communicated with the exhaust ports of the battery stacks.

### Advantageous Effects of Invention

According to the battery unit in the present invention, since the exhaust duct is integrally provided on the bus bar unit, it is possible to eject the gas emitted from the battery cells to the exterior of the module with a simple configuration.

### BRIEF DESCRIPTION OF DRAWINGS

FIG. 1 is a perspective view showing a battery unit in an embodiment.

FIG. 2 is an exploded perspective view of a bus bar unit in the battery unit in FIG. 1.

FIG. 3 is a front view of the bus bar unit of the battery unit in FIG. 1.

FIG. 4 is a perspective view showing a battery block included in each of a plurality of battery stacks that constitute the battery unit.

FIG. 5 is a sectional view of one battery unit that constitutes the battery unit, taken from line A-A in FIG. 1.

FIG. 6 is a diagram showing a modification of the bus bar unit and corresponding to FIG. 3.

FIG. 7 is a diagram showing another modification of the bus bar unit and corresponding to FIG. 3.

### DESCRIPTION OF EMBODIMENTS

Hereinafter, embodiments according to the present invention will be described in detail, with reference to the accompanying drawings. In the description, specific shapes, materials, numerical values, directions and the like are examples for facilitating the understanding of the present invention, and may be appropriately altered according to usage, purpose, specification and the like. Further, hereinafter, in the case of including a plurality of embodiments, modifications and the like, it is considered from the beginning to use the characteristic parts by appropriately combining them.

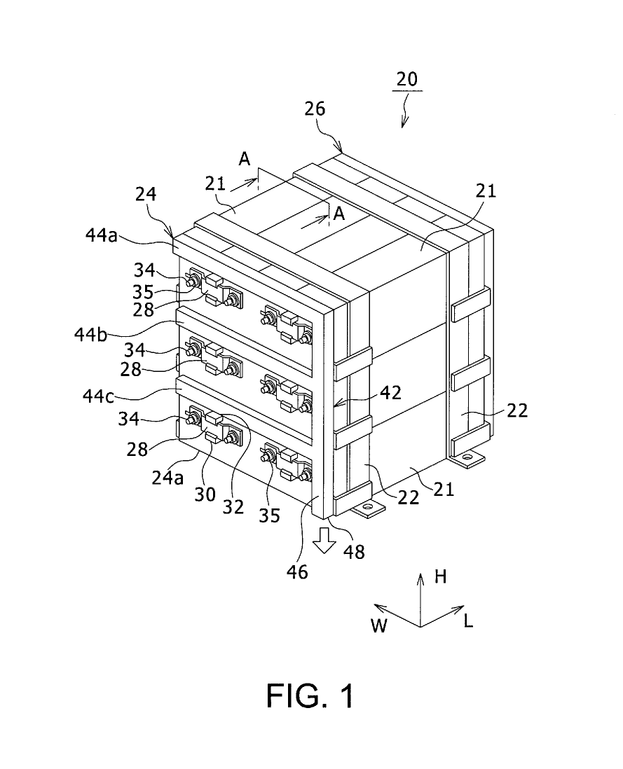

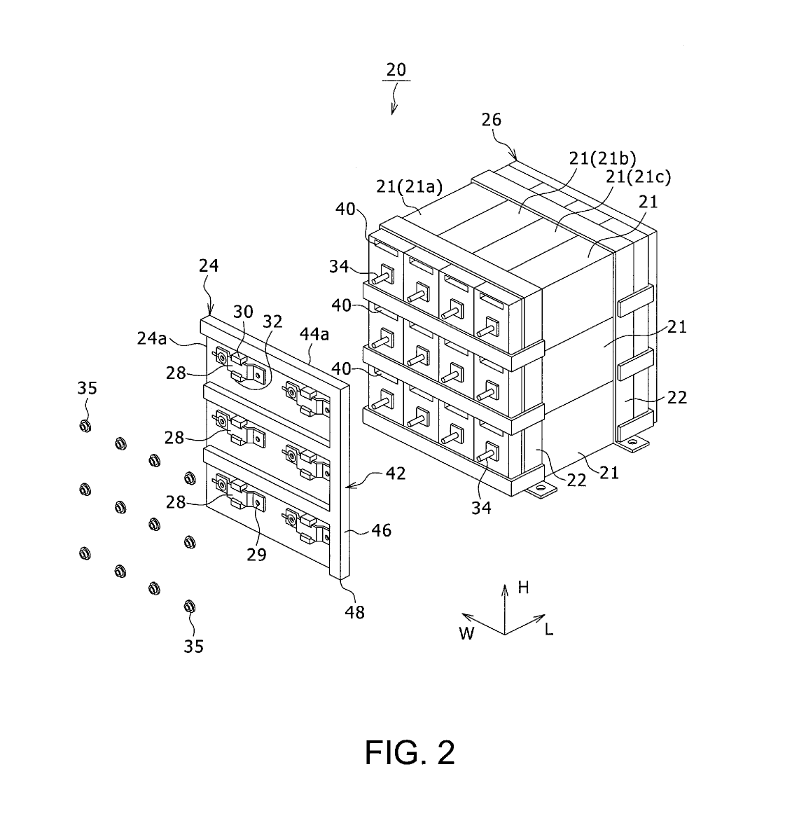

FIG. 1 is a perspective view showing the whole of a battery unit 20 that is an embodiment of the present invention. Further, FIG. 2 is an exploded perspective view showing a bus bar unit in the battery unit 20 in FIG. 1. In FIG. 1 and FIG. 2, a height direction H, a length direction L and a width direction W are shown as three axis directions orthogonal to each other. The height direction H is the vertical direction or perpendicular direction when the battery unit 20 is placed on a horizontal plane. Further, the length direction L and the width direction W are the directions orthogonal to each other on the horizontal plane. Here, in the dimensions of a battery stack 21 included in the battery unit 20, the longer direction is the length direction L, and the shorter direction is the width direction W. The same goes for the following figures.

As shown in FIG. 1 and FIG. 2, the battery unit 20 is configured by integrally combining a plurality of battery stacks 21. Each battery stack 21 has a rectangular shape. In the embodiment, 12 battery stacks 21 are stacked in a matrix of 3 rows and 4 columns. Then, the integrally combined battery stacks 21 are fixed, for example, on a bottom part of a member (not illustrated) in a vehicle body, with two gate-shaped fixation members 22, each of which is formed of a belt-shaped metal member, by a method such as screw fixation. The number of the battery stacks 21 to constitute the battery unit 20 is not limited to 12 described above, and is appropriately altered depending on the output and capacity required for the battery unit 20.

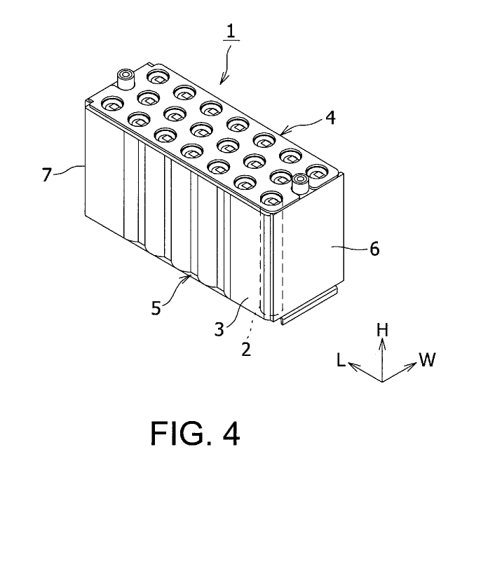

On both end parts in the length direction of each battery stack 21 described above, terminal parts 34 are provided so as to protrude in the length direction. Of these, the terminal part 34 on one end side is a positive electrode terminal, and the terminal part 34 on the other end side is a negative electrode terminal. Here, FIG. 1 and FIG. 2 illustrate only the terminal part 34 on the one end side. The terminal part 34, which is electrically connected with electrodes of battery cells 2 (see FIG. 4) as the minimum unit included in the battery stack 21, is an input-output terminal for performing the charge and discharge for the battery cells 2. Further, a male screw, not illustrated, is formed on the periphery of the terminal part 34.

The battery unit 20 includes bus bar units 24, 26 on both end parts in the length direction L. The bus bar units 24, 26 have a function to electrically connect the battery stacks 21 included in the battery unit 20, for example, in series.

One bus bar unit 24 will be described more specifically. The bus bar unit 24 supports a plurality of bus bar members 28, each of which connects the terminal parts 34 respectively protruding from the one-side end parts of two adjacent battery stacks 21 with each other. The bus bar member 28 is formed by the folding of a metal plate, and through holes 29 for inserting the terminal parts 34 are formed at both end parts, respectively.

Further, a bus bar support plate 24a configuring the bus bar unit 24, for example, is formed of an insulating material such as resin, in a plate shape. In the bus bar support plate 24a, on the surface of the opposite side of the battery stack 21, bus bar support claws 30, 32 are formed in a hook shape so as to face each other. The bus bar member 28 is inserted between the support claws 30, 32 to engage with them, and thereby, the bus bar member 28 is put into a state of being supported on the surface of the bus bar support plate 24a.

Further, on the bus bar support plate 24a, through holes (not illustrated) are formed at positions corresponding to the respective terminal parts 34 of the battery stacks 21 that are arrayed and arranged in 3 rows and 4 columns. The bus bar member 28 is mounted on the bus bar support plate 24a in a state in which the positional adjustment of the through holes 29 of the bus bar member 28 has been performed with the through holes of the bus bar support plate 24a. Thereby, the terminal parts 34 of the arrayed and arranged battery stacks 21 can be mounted so as to pierce and protrude through the bus bar support plate 24a and the bus bar members 28. Then, in this state, nuts 35 are screwed into the terminal parts 34, and thereby, the bus bar unit 24 can be fixed to the battery stacks 21.

The bus bar unit 26 of the other side also supports bus bar members for electrically connecting the terminal parts 34 of the arrayed and arranged battery stacks 21 with each other, but is different from the above bus bar unit 24 in the attachment positions of the bus bar members. For example, in FIG. 1 and FIG. 2, the bus bar member 28 shown at the left side of the upper stage electrically connects the terminal parts 34 of a battery stack 21a and a battery stack 21b with each other, but in the bus bar unit 26, the bus bar member (not illustrated) arranged at the upper stage is arranged so as to electrically connect the terminal parts 34 of the battery stack 21b and a battery stack 21c with each other.

Here, on the bus bar unit 26 of the other side, an exhaust duct described later does not need to be provided, but the exhaust duct may be provided similarly to the bus bar unit 24. In this case, it is necessary to also form an exhaust port on the end surface of the other side of the battery stack 21.

Thus, in the battery unit 20 according to the embodiment, the terminal parts 34 of the arrayed and arranged battery stacks 21 are configured such that all battery stacks 21 are connected in series, by the bus bar units 24, 26. Further, the bus bar units 24, 26 fixed to the battery stacks 21 through the terminal parts 34 also have a function to keep the arrayed and arranged battery stacks 21 bound in cooperation with the fixation members 22.

It has been described above that the bus bar units 24, 26 connect the battery stacks 21 in series, but without being limited to this, the battery unit may be configured such that the battery stacks 21 are connected in parallel, by changing the shape of the bus bar members provided on the bus bar units.

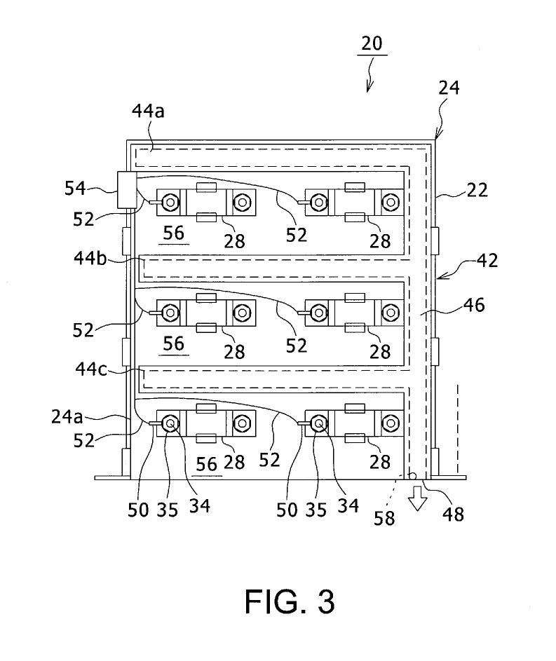

Next, the exhaust structure of the battery unit 20 will be described with reference to FIG. 3 in addition to FIG. 1 and FIG. 2. FIG. 3 is a front view of the bus bar unit 24 of the battery unit 20 in FIG. 1.

As shown in FIG. 2, at positions that are on the end surfaces of the battery stacks 21 constituting the battery unit 20 and that are above the terminal parts 34, exhaust ports 40 are formed so as to be opened, respectively. The exhaust port 40 is an opening part for ejecting, from the battery stack 21, the gas emitted from the battery cells 2 included in the battery stack 21.

As shown in FIG. 1 to FIG. 3, an exhaust duct 42 is integrally provided on the above-described bus bar unit 24. The exhaust duct 42 includes a first branch duct part 44a that is communicated with the respective exhaust ports 40 of the four battery stacks 21 arranged at the upper stage, and that extends in the width direction W, a second branch duct part 44b that is communicated with the respective exhaust ports 40 of the four battery stacks 21 arranged at the middle stage and that extends in the width direction W, a third branch duct part 44c that is communicated with the respective exhaust ports 40 of the four battery stacks 21 arranged at the lower stage and that extends in the width direction W, and a collection duct part 46 that is communicated with one end part of each of the first to third branch duct parts 44a, 44b, 44c and that extends in the height direction H.

The other end parts of the above first to third branch duct parts 44a, 44b, 44c that are on the opposite side of the collection duct part 46 are each closed. Further, the above first to third branch duct parts 44a, 44b, 44c and collection duct part 46 have an internal space in which the cross section has, for example, a rectangular shape, and constitute a passage through which the gas emitted from the exhaust ports 40 flows. Furthermore, a duct outlet 48 is formed at the lower end part of the collection duct part 46, and the gas having flowed from the battery stacks 21 through the exhaust ports 40 into the exhaust duct 42 is ejected from the duct outlet 48 to the exterior of the module. The outlined arrow shows a manner in which the gas is ejected from the duct outlet 48.

Further, in the embodiment, the collection duct part 46 of the exhaust duct 42 is formed so as to extend along the edge part of the bus bar unit 24. Specifically, the collection duct part 46 is formed linearly along a one-side edge part of the bus bar support plate 24a having a rectangular shape. Thereby, the branch duct parts 44a, 44b, 44c and the collection duct part 46 are formed in a comb tooth shape. Thus, by adopting a configuration in which the gas ejected from the exhaust ports 40 of the battery stacks 21 flows from the branch duct parts 44a, 44b, 44c into the collection duct part 46 and is exhausted from the duct outlet 48 provided at the lower end part of the collection duct part 46 to the exterior, it is possible to increase the exhaust gas passage lengths from the exhaust ports 40 to the duct outlet 48.

Furthermore, in the bus bar unit 24, the exhaust duct 42 including the first to third branch duct parts 44a, 44b, 44c and the collection duct part 46 is formed in a shape in which it protrudes from the surface of the bus bar support plate 24a that is on the opposite side of the battery stacks 21. Thereby, concave spaces of the protruding exhaust duct 42 constitute containing parts 56 that contain the bus bar members 28.

Further, a measurement terminal 50 is fastened to one of the terminal parts 34 positioned at both end parts of the bus bar member 28, by the nut 35. A measurement harness 52 extending from the measurement terminal 50 extends to a connector 54 attached to the bus bar unit 24 by a method such as adhesion, interlocking and screw fixation, for example, and is connected with the connector 54. An electronic control unit (ECU) connected with the connector 54 then monitors the state (for example, the voltage or the like) of the battery stack 21 through the measurement harness 52.

Such a measurement harness 52 is also contained in the above-described concave containing part 56 together with the bus bar member 28. Therefore, it is possible to avoid the bus bar member 28 and the measurement harness 52 from jutting out of the end surface of the bus bar unit 24 (that is, the end surface of the exhaust duct 42). As a result, the mounting of the bus bar unit 24 is facilitated, and it is possible to eliminate a problem where the measurement harness 52 is caught and cut.

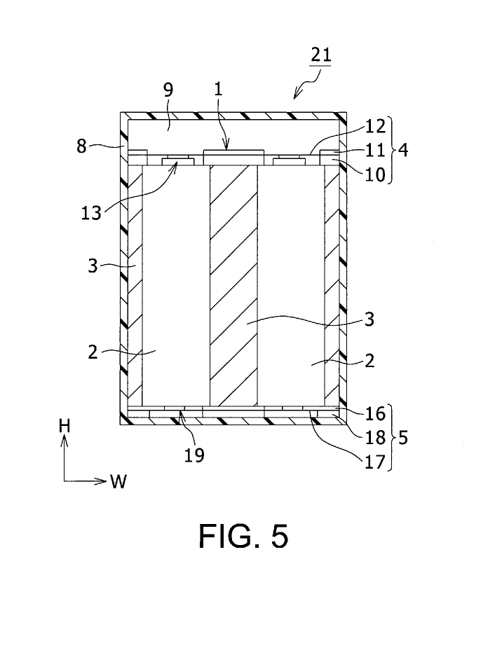

Here, the internal structure of the battery stack 21 is described with reference to FIG. 4 and FIG. 5. FIG. 4 is a perspective view showing a battery block 1 included in each of the plurality of battery stacks 21 that constitute the battery unit 20. Further, FIG. 5 is a sectional view of one battery stack 21 that constitutes the battery unit 20, taken from line A-A in FIG. 1.

Each battery stack 21 of the battery unit 20 in the embodiment is configured to include, for example, two battery blocks 1 shown in FIG. 4 that are connected in series. In the battery block 1, a plurality of battery cells 2 are connected in parallel such that a predetermined capacity is obtained. Here, an example in which 20 battery cells 2 are used is shown. In the battery block 1, the 20 battery cells 2 are arrayed and arranged in a predetermined arrangement relation such that the positive electrode sides are ordered on one side and the negative electrode sides are ordered on the other side, and are stored and held in a battery cell case 3. Further, a positive electrode side collector unit 4 is arranged on the positive electrode side, a negative electrode side collector unit 5 is arranged on the negative electrode side, and the positive electrode side collector unit 4 and the negative electrode side collector unit 5 are fastened through holders 6, 7, by an appropriate fastening member or the like.

The battery cell 2 is a secondary battery capable of being charged and discharged, and constitutes the battery unit 20 as a minimum battery unit. As the secondary battery, a lithium-ion battery is used. Other than this, a nickel-metal hydride battery, an alkali battery or the like may be used. The 20 battery cells 2 included in the battery block 1 have a zigzag arrangement relation that minimizes the clearance between adjacent batteries, with three battery arrays being arranged in the width direction W, and seven, six and seven battery cells 2 being arranged along the length direction L, on the battery arrays, respectively.

The battery cell 2 has a cylindrical external shape. One end of both end parts of the cylindrical shape is used as the positive electrode terminal, and the other end is used as the negative electrode terminal. In the embodiment, the positive electrode terminal is provided on the upper end of the battery cell 2 shown in FIG. 5, and the negative electrode terminal is provided on the lower end. As an example of each battery cell 2, there is a lithium-ion battery in which the diameter is 18 mm, the height is 65 mm, the voltage between the terminals is 3.6 V and the capacity is 2.5 Ah. This is an example for description, and dimensions or characteristic values other than these may be adopted. Here, the battery cell 2 is not limited to a cylindrical battery, and may be a battery having another external shape.

The battery cell 2 has a safety valve 13 on the positive electrode terminal side. The safety valve 13 has a function to release exhaust gas from the interior of the battery to the exterior of the cell when the pressure of the gas generated by an electrochemical reaction that is performed in the interior of the battery cell 2 exceeds a previously determined threshold pressure.

The battery cell case 3 is a holding container for holding the 20 battery cells 2 such that they are arrayed and arranged in a predetermined arrangement relation. The battery cell case 3 is a frame body having the same height as the height of the battery cell 2 and provided with 20 through-hole shaped battery storage parts that are opened on each of both end sides in the height direction H, and each battery cell 2 is stored and arranged in one of the battery storage parts.

The arrangement of the battery storage parts is a zigzag arrangement relation corresponding to the arrangement relation of the battery cells 2. That is, three battery storage part arrays are arranged in the width direction W, and the battery storage part arrays have seven, six and seven battery storage parts along the length direction L, respectively. As the battery cell case 3, there can be used a battery cell case that adopts aluminum as the main material and that has a predetermined shape by formed extrusion molding.

In the battery cell case 3, when the 20 battery cells 2 are stored and arranged in the battery storage parts, the positive electrode sides of the battery cells 2 are ordered on one side, and the negative electrode sides are ordered on the other side. In FIG. 5, the one side is the upper side along the height direction H on the sheet plane, and the other side is the lower side along the height direction H on the sheet plane.

The positive electrode side collector unit 4 is a connection member that is arranged so as to close the opening on one side of the battery cell case 3 and that electrically connects the respective positive electrode sides of the arrayed and arranged battery cells 2. The positive electrode side collector unit 4 is constituted by a positive electrode side insulating plate 10, a positive electrode collector 11 and a positive electrode plate 12.

The positive electrode side insulating plate 10 is a plate member that is arranged between the battery cell case 3, and the positive electrode collector 11 and positive electrode plate 12, and that insulates electrically the positive electrode collector 11 and positive electrode plate 12 from the battery cell case 3. The positive electrode side insulating plate 10 is provided with 20 openings that have a circular shape or the like and that allow the positive electrodes of the battery cells 2 to protrude. As the positive electrode side insulating plate 10, there is used a plastic article or plastic sheet that has a predetermined heat resistance property and electrical insulation property, and that is processed in a predetermined shape.

The positive electrode collector 11 is a thin plate including 20 electrode contact parts that are arranged in a positional relation in which they contact with the positive electrodes of the battery cells 2 respectively and individually. As the positive electrode collector 11, there can be used a metal thin plate having an electrically conductive property and forming electrode contact parts each of which has a predetermined shape and in each of which a roughly C-shaped cutout part is formed at the periphery by etching, press processing or the like.

The positive electrode plate 12 is an electrode plate that is electrically connected with the positive electrode collector 11 and that mutually connects the 20 electrode contact parts to constitute one positive electrode side output terminal. As the positive electrode plate 12, there can be used a metal thin plate having an electrically conductive property, and having an appropriate thickness and strength. As the positive electrode plate 12, there can be used a metal thin plate forming electrode contact parts each of which has a predetermined shape and in each of which an opening having a circular shape or the like is formed by etching, press processing or the like.

The negative electrode side collector unit 5 is a connection member that is arranged at the opening on the other side of the battery cell case 3 and that electrically connects the respective negative sides of the arrayed and arranged battery cells 2. The negative electrode side collector unit 5 is constituted by a negative electrode side insulating plate 16, a negative electrode collector 17 and a negative electrode plate 18.

The negative electrode side insulating plate 16 is a plate member that is arranged between the battery cell case 3, and the negative electrode collector 17 and negative electrode plate 18, and that insulates electrically the negative electrode collector 17 and negative electrode plate 18 from the battery cell case 3. The negative electrode side insulating plate 16 is provided with 20 openings that have a circular shape or the like and that expose the negative electrodes of the battery cells 2. As the negative electrode side insulating plate 16, there is used a plastic article or plastic sheet that has a predetermined heat resistance property and an electrically insulation property, and that is processed in a predetermined shape.

The negative electrode collector 17 is an electrode member including 20 electrode contact parts that are arranged in a positional relation in which they contact with the negative electrodes of the battery cells 2 respectively and individually. As the negative electrode collector 17, there can be used a metal thin plate having an electrically conductive property and forming electrode contact parts separated by forming roughly C-shaped cutout parts by etching, press processing or the like. Further, the electrode contact part of the negative electrode collector 17 may be provided with a current breaking element that fuses when overcurrent flows through the battery cell 2 and thereby the temperature exceeds a previously determined threshold temperature.

The negative electrode plate 18 is an electrode plate that is electrically connected with the negative electrode collector 17 and that mutually connects the 20 respective electrode contact parts to constitute one negative electrode side output terminal. As the negative electrode plate 18, there can be used a metal thin plate that has an electrically conductive property, that has an appropriate thickness and strength, and on which openings having a circular shape or the like are formed by etching, press processing or the like, corresponding to the electrode contact parts of the negative electrode collector 17.

The holders 6, 7 are members for fastening the positive electrode side collector unit 4 arranged on one side of the battery cell case 3 and the negative electrode side collector unit 5 arranged on the other side with use of a fastening member such as a bolt, for example, and integrating the battery cell case 3, the positive electrode side collector unit 4 and the negative electrode side collector unit 5 as a whole, and is composed of an insulating material. Here, the holders do not need to be configured separately, and for example, the side part covering the side surface of the battery cell case 3, the upper part covering the positive electrode side, and the lower part covering the negative electrode side may be integrally configured.

Two battery blocks 1 having the above configuration are prepared and laterally arranged, and a pointed end part of the positive electrode plate 12 of the battery block 1 on one side and a pointed end part of the negative electrode plate 18 of the battery block 1 on the other side are connected with each other electrically and mechanically, by a connection fixation method such as welding. Then, the two battery blocks 1 connected in this way are stored in a battery module case 8 composed of, for example, resin or the like, and thereby the battery stack 21 is configured.

In the battery module case 8, a duct chamber 9 that is a space is formed above the battery blocks 1. The duct chamber 9 faces, through the opening parts and the cutout parts, the positive electrode terminals of the battery cells 2 that are provided with the safety valves 13, and is communicated with the exhaust port 40 formed on the end surface of the battery stack 21. Thereby, the gas emitted from the safety valves 13 of the battery cells 2 is ejected, through the duct chamber 9 and further the exhaust port 40, from the battery stack 21 to the exterior.

It has been described above that the duct chamber 9 is formed in the interior of the battery module case 8 made of resin, in which the plurality of battery blocks 1 connected with each other in series are stored, but without being limited to this, the duct chamber may be formed by covering only the upper part of the battery blocks 1 with a cover member made of a metal plate that has a relatively high heat resistance property.

Subsequently, the gas exhaust operation of the battery unit 20 having the above configuration will be described.

When the internal pressure increases in the battery cell 2 included in the battery unit 20 and the safety valve 13 operates, the high-temperature (for example, about 400° C.) gas emitted from the safety valve 13 flows, through the duct chamber 9 in the battery stack 21, from the exhaust port 40 into at least any one of the first to third branch duct parts 44a, 44b, 44c of the bus bar unit 24. Then, the gas flows from the branch duct parts 44a, 44b, 44c to the collection duct part 46, and is ejected from the duct outlet 48 to the exterior of the battery unit 20.

While it flows through the branch duct parts 44a, 44b, 44c and the collection duct part 46 in this way, the gas temperature can be decreased to a temperature level (for example, about 100° C.) that causes no problem even if it is ejected to the exterior of the battery unit 20.

Therefore, according to the battery unit 20 in the embodiment, with a simple configuration in which the exhaust duct 42 is integrally provided on the bus bar unit 24, it is possible to decrease the temperature of the gas emitted from the battery cell 2 to a safe temperature and to eject it to the exterior of the module, without adding special components for the exhaust structure.

Here, the battery unit according to the present invention is not limited to the configuration of the above-described embodiment, and various modifications and improvements are possible in a range of the matters described in the claims and their equivalents.

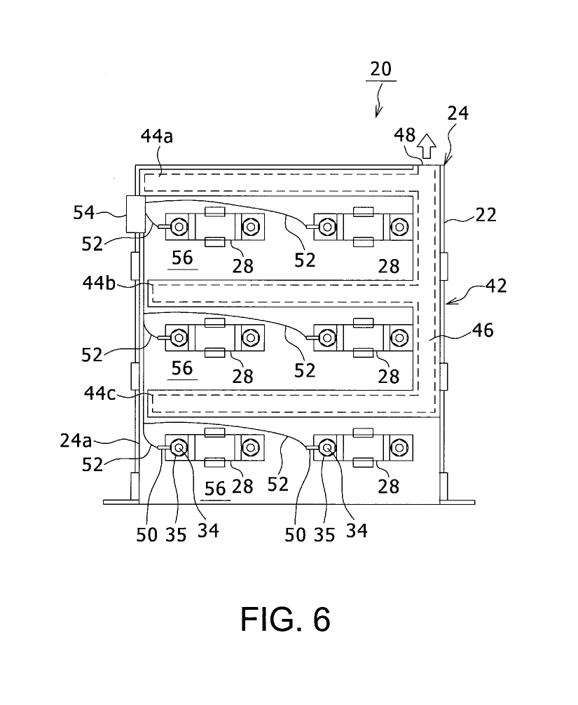

In the above embodiment, the duct outlet 48 of the exhaust duct 42 of the bus bar unit 24 is formed such that the exhaust is performed downward, but is not limited to this. For example, as shown in FIG. 6, the duct outlet 48 may be provided on the upper end part of the collection duct part 46, and thereby, the gas may be ejected upward. Thus, by appropriately altering the exhaust direction from the battery unit 20, the optimal exhaust direction may be selected depending on the structure of a vehicle or apparatus in which the battery unit is installed, the installation location and the like.

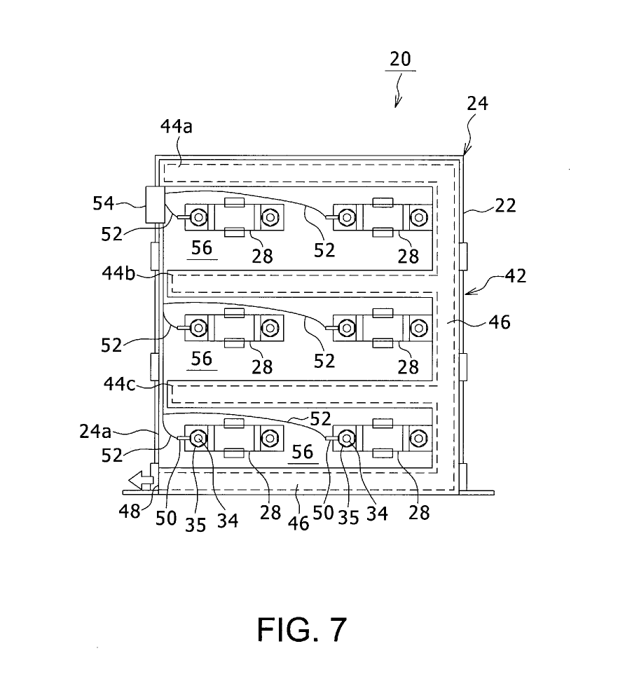

Further, in the description of the above embodiment, the collection duct part 46 of the exhaust duct 42 is provided along the one-side edge part of the bus bar unit 24, but is not limited to this. For example, as shown in FIG. 7, the collection duct part 46 of the exhaust duct 42 is configured to further extend along the lower end side edge part from the one-side edge part of the bus bar unit 24 such that the exhaust is performed laterally from the bus bar unit 24. Thereby, the exhaust gas passage length becomes longer, and therefore, there is an advantage in that the gas temperature at the release time further decreases.

Further, it has been described above that the two battery blocks 1 connected in series are included in the battery stack 21 constituting the battery unit 20. However, only a single battery block 1 may be included, two battery blocks 1 connected in parallel may be included, or three or more battery blocks 1 connected in series or in parallel may be included.

Furthermore, in the above embodiment, the single battery unit 20 has been described, but, for example, when two battery units 20 are stacked and installed, the opening part may also be formed on the upper end part of the collection duct part 46 of the exhaust duct 42 in the battery unit 20 positioned at the lower side, and may be coupled with the duct outlet 48 of the exhaust duct 42 in the battery unit 20 placed at the upper side, directly or through a tubular connection member.

Moreover, as shown in FIG. 3, a temperature fuse 58 that fuses at a predetermined temperature (for example, about 100° C.) may be provided at the duct outlet 48 of the collection duct part 46 of the exhaust duct 42, and may detect the emission of the gas from the battery cell 2 in the battery unit 20. The temperature fuse 58 may be in the interior of the duct, or may be in the exterior of the duct. Thereby, it is possible to inform a user (or a driver) of the actuation of the safety valve 13 of the battery cell 2 included in the battery unit 20, for example, by lamp lighting.

### REFERENCE SIGNS LIST

1 battery block, 2 battery cell, 3 battery cell case, 4 positive electrode side collector unit, 5 negative electrode side collector unit, 6, 7 holder, 8 battery module case, 9 duct chamber, 10 positive electrode side insulating plate, 11 positive electrode collector, 12 positive electrode plate, 13 safety valve, 16 negative electrode side insulating plate, 17 negative electrode collector, 18 negative electrode plate, 19 fuse, 20 battery unit, 21, 21a, 21b, 21c battery stack, 22 fixation member, 24, 26 bus bar unit, 24a bus bar support plate, 24, 26 bus bar unit, 28 bus bar member, 29 through hole, 30, 32 bus bar support claw, 34 terminal part (terminal), 35 nut, 40 exhaust port, 42 exhaust duct, 44a first branch duct part, 44b second branch duct part, 44c third branch duct part, 46 collection duct part, 48 duct outlet, 50 measurement terminal, 52 measurement harness, 54 connector, 56 containing part, 58 temperature fuse, H height direction, L length direction, W width direction

1. A battery unit comprising:
a plurality of battery stacks each of which includes a plurality of battery cells and has a terminal and an exhaust port, the terminal being electrically connected with electrodes of the battery cells, the exhaust port exhausting gas emitted from the battery cells; and
a bus bar unit that supports a bus bar member electrically connecting terminal parts of the battery stacks with each other,
wherein an exhaust duct is integrally provided on the bus bar unit, the exhaust duct being an exhaust duct for ejecting the gas emitted from the battery cells to an exterior of a module and being communicated with the exhaust ports of the battery stacks.

2. The battery unit according to claim 1,
wherein the exhaust duct includes a collection duct part and a branch duct part, the collection duct part having a duct outlet at an end part, the branch duct branching from the collection duct part so as to be communicated with at least one of the exhaust ports of the battery stacks.

3. The battery unit according to claim 2,
wherein the collection duct part of the exhaust duct is formed so as to extend along an edge part of the bus bar unit.

4. The battery unit according to claim 2,
wherein a temperature fuse that fuses at a predetermined temperature is provided at the duct outlet of the collection duct part.

5. The battery unit according to claim 1,
wherein the exhaust duct is formed so as to protrude from a bus bar unit surface on an opposite side of a battery stack side, and a space of the protruding exhaust duct constitutes a containing part that contains the bus bar member and a measurement harness electrically connected with the bus bar member.

6. The battery unit according to claim 3,
wherein a temperature fuse that fuses at a predetermined temperature is provided at the duct outlet of the collection duct part.

7. The battery unit according to claim 2,
wherein the exhaust duct is formed so as to protrude from a bus bar unit surface on an opposite side of a battery stack side, and a space of the protruding exhaust duct constitutes a containing part that contains the bus bar member and a measurement harness electrically connected with the bus bar member.

8. The battery unit according to claim 3,
wherein the exhaust duct is formed so as to protrude from a bus bar unit surface on an opposite side of a battery stack side, and a space of the protruding exhaust duct constitutes a containing part that contains the bus bar member and a measurement harness electrically connected with the bus bar member.

9. The battery unit according to claim 4,
wherein the exhaust duct is formed so as to protrude from a bus bar unit surface on an opposite side of a battery stack side, and a space of the protruding exhaust duct constitutes a containing part that contains the bus bar member and a measurement harness electrically connected with the bus bar member.

10. The battery unit according to claim 5,
wherein the exhaust duct is formed so as to protrude from a bus bar unit surface on an opposite side of a battery stack side, and a space of the protruding exhaust duct constitutes a containing part that contains the bus bar member and a measurement harness electrically connected with the bus bar member.
